(19) United States
(12) Patent Application Publication
(10) Pub. No.: US 2023/0266749 A1
(43) Pub. Date: Aug. 24, 2023

(54) METHOD OF CONTROLLING INFORMATION PROCESSING APPARATUS, INFORMATION PROCESSING APPARATUS, RECORDING MEDIUM, INFORMATION PROCESSING SYSTEM, PRODUCTION SYSTEM, AND METHOD OF MANUFACTURING PRODUCTS

(71) Applicant: CANON KABUSHIKI KAISHA, Tokyo (JP)

(72) Inventor: Hiroki Kanai, Tokyo (JP)

(21) Appl. No.: 18/106,516

(22) Filed: Feb. 7, 2023

(30) Foreign Application Priority Data
Feb. 24, 2022 (JP) 2022-026907

(51) Int. Cl. G05B 19/418; G05B 23/02

(52) U.S. Cl. CPC G05B 19/41875; G05B 23/0283; G05B 23/027

(57) ABSTRACT

An information processing apparatus includes a processing portion. The processing portion is configured to obtain information on a location of a worker associated with time information, and information on a state of a production apparatus associated with the time information. And the processing portion is configured to display an accumulated time on a display portion by using the obtained information, the accumulated time being obtained in a predetermined combination of the location of the worker and the state of the production apparatus.

### BACKGROUND OF THE INVENTION

### Field of the Invention

The present invention relates to an information processing method and an information processing apparatus.

### Description of the Related Art

For increasing the productivity in a production site, information on a worker and on the state of an apparatus is collected.

Japanese Patent Application Publication No. 2020-144439 proposes a system that recognizes, records, and analyzes location information of a worker and operation information of a facility. The location information and the operation information are obtained by capturing a color 1 of the worker for identifying the worker and capturing a color 2 of the facility for identifying the state of the facility, by using a camera and performing image processing on the image captured by the camera.

Japanese Patent Application Publication No. 2010-257296 proposes a system that displays a man-machine chart. The system causes sensors to detect the presence of a workpiece and the location of a worker; writes data on the presence of the workpiece and data on the location of the worker, into a database, as operation information of the facility and location information of the worker; associates the operation state of the facility and the location information of the worker with each other; and displays the operation state of the facility and the location information of the worker, associated with each other, as the man-machine chart.

### SUMMARY OF THE INVENTION

According to a first aspect of the present invention, a method of controlling an information processing apparatus includes obtaining, by the information processing apparatus, information on a location of a worker associated with time information, and information on a state of a production apparatus associated with the time information, and displaying, by the information processing apparatus, an accumulated time in a predetermined combination of the location of the worker and the state of the production apparatus.

According to a second aspect of the present invention, an information processing apparatus includes a processing portion. The processing portion is configured to obtain information on a location of a worker associated with time information, and information on a state of a production apparatus associated with the time information. And the processing portion is configured to display an accumulated time on a display portion by using the obtained information, the accumulated time being obtained in a predetermined combination of the location of the worker and the state of the production apparatus.

Further features of the present invention will become apparent from the following description of exemplary embodiments with reference to the attached drawings.

### BRIEF DESCRIPTION OF THE DRAWINGS

FIG. 1 is a schematic diagram of a production apparatus to which an information processing system of a first embodiment is applied.

FIG. 2 is a schematic diagram illustrating a block configuration of a node apparatus.

FIG. 3 is a schematic diagram illustrating a block configuration of a management apparatus (server) 117 of the first embodiment.

FIG. 4 is a flowchart illustrating a procedure of one example of data processing performed by the management apparatus 117.

FIG. 5 is a diagram illustrating a format of data used in each process.

FIG. 6 is a flowchart illustrating a procedure of processes performed by the management apparatus 117 for creating and displaying a time-series chart in which the state of a production apparatus and the location of a worker are organized in time series.

FIG. 7 is a flowchart illustrating a procedure of processes performed by the management apparatus 117 for creating and displaying an accumulated-time matrix display screen obtained by calculating an accumulated time in a predetermined period of time for each combination of the state of a production apparatus and the location of a worker.

FIG. 8 is a diagram illustrating one example of a sensor-name setting table 501.

FIG. 9 is a diagram illustrating one example of a time-series-chart display screen 601.

FIG. 10 is a diagram illustrating one example of an accumulated-time matrix display screen 701.

FIG. 11A is a diagram illustrating one example of an alert setting screen.

FIG. 11B is a diagram illustrating another example of an alert setting screen.

FIG. 12 is a schematic diagram of a production apparatus to which an information processing system of a second embodiment is applied.

FIG. 13 is a schematic diagram illustrating a block configuration of a management apparatus (server) 117 of the second embodiment.

FIG. 14 is a flowchart illustrating a procedure of one example of data processing performed by the management apparatus 117.

FIG. 15A is a diagram for illustrating calculation of a maintenance recommendation time, performed by a failure prediction portion.

FIG. 15B is a diagram illustrating an example in which a maintenance recommendation time obtained by performing extrapolation is displayed in the time-series-chart display screen 601.

### DESCRIPTION OF THE EMBODIMENTS

Japanese Patent Application Publication No. 2020-144439 or 2010-257296 proposes a method of collecting and displaying the location information of a worker and the operation information of a facility, but fails to fully study how the collected information is processed for increasing the productivity and operating the facility appropriately.

Thus, it has been desired to achieve an information processing method and an information processing apparatus that are effective for increasing the productivity and operating the facility appropriately by using the location information of a worker and the information on the state of the facility in a production site.

Next, an information processing method, an information processing apparatus, and the like of an embodiment of the present invention will be described with reference to the accompanying drawings. Note that since the embodiments described below are examples, a detailed configuration or the like may be modified as appropriate by a person skilled in the art, without departing the spirit of the present invention. In addition, in the drawings that are referred to in the following embodiments, a component given an identical reference numeral has an identical function, unless otherwise specified.

### First Embodiment

### Information Processing System

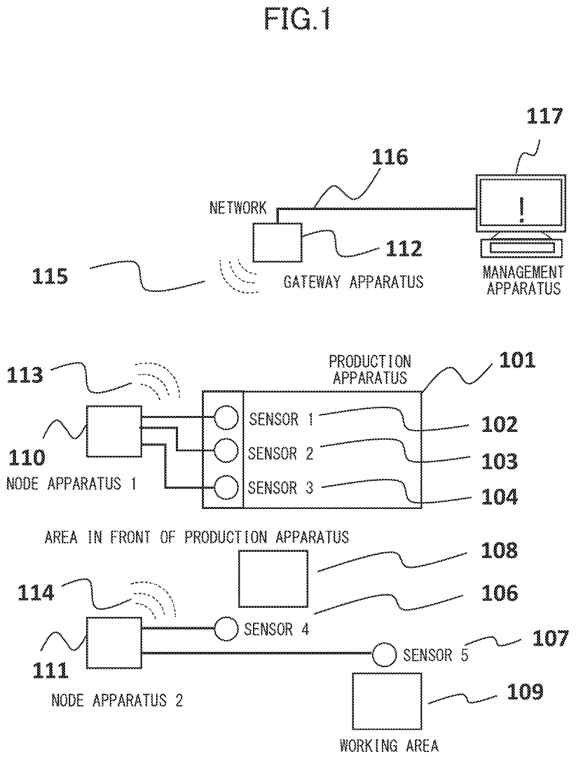

FIG. 1 is a schematic diagram of a production apparatus to which an information processing system of a first embodiment of the present invention is applied. Note that since the production apparatus illustrated in FIG. 1 is one example, the configuration of the production apparatus may be modified appropriately in accordance with the situation of a production site, such as the number of sensors, types of the sensors, arrangement of the sensors, or the number of node apparatuses.

In a production apparatus 101, sensors 102, 103, and 104 are disposed for obtaining information on the operation state of the production apparatus 101. The sensors 102, 103, and 104 detect states of the production apparatus 101, such as a processing state, a stop state, and an error state, as the operation state of the production apparatus 101. For example, the sensors may be clamp type current sensors that are set on a power supply line of the production apparatus 101. However, the sensors may not be the current sensors as long as the sensors can detect the operation state of the production apparatus. For example, the sensors may be vibration sensors, acceleration sensors, pressure sensors, photosensors, torque sensors, temperature sensors, or sound wave sensors, which are selected in accordance with the property of the production apparatus. If a signal lamp is disposed in the production apparatus, an illuminance sensor may be used for detecting the lighting pattern of the signal lamp. In this case, the operation state of the production apparatus can be determined in a simple configuration.

The information processing system includes sensors 106 and 107 that serve as location sensors for detecting the location of a worker. The location sensors used may be infrared human sensors, mat switches, sensors that detect a position of an RFID held by a worker, or monitoring cameras having an image processing function and capable of detecting a person. The infrared human sensor is suitable because it can be easily installed and causes workers to feel less stress, compared with the monitoring camera or the like, because the workers are not excessively conscious of being monitored by the infrared human sensor. In this example, the sensor 106 is disposed in an area 108 in front of the production apparatus, and the sensor 107 is disposed in a working area 109. The area 108 is an area in which a worker performs the operation or the maintenance work of the production apparatus, and the working area 109 is an area in which the worker performs another type of work.

The information processing system also includes a node apparatus 110 that transmits signals outputted from the sensors 102, 103, and 104, and a node apparatus 111 that transmits signals outputted from the sensors 106 and 107. One node apparatus can be connected with a plurality of sensors. In another system, however, one node apparatus may serve as the node apparatuses 110 and 111 in accordance with the arrangement of the sensors.

The node apparatus 110 includes a communication unit 113, the node apparatus 111 includes a communication unit 114, and a gateway apparatus 112 includes a communication unit 115. The node apparatus 110 can communicate with the gateway apparatus 112 via the communication unit 113 and the communication unit 115, and the node apparatus 111 can communicate with the gateway apparatus 112 via the communication unit 114 and the communication unit 115. Each of the communication units 113, 114, and 115 includes one or more communication portions, selected appropriately from wireless communications including low power wide area (LPWA) and wireless LAN, and wire communications including Ethernet and Field Level Network.

The measurement data measured by using the sensors is sent from the node apparatus 110 to the gateway apparatus 112 via the communication unit 113 and the communication unit 115, and from the node apparatus 111 to the gateway apparatus 112 via the communication unit 114 and the communication unit 115; and is collected in the gateway apparatus 112. The gateway apparatus 112 is connected with a network 116. Note that the network 116 may be a dedicated network used in a plant, or may be a wide area network such as the Internet. The gateway apparatus 112 is disposed within a distance that allows the gateway apparatus 112 to communicate with the node apparatuses 110 and 111. The measurement data collected in the gateway apparatus 112 is transmitted to the management apparatus (server) 117 via the network 116, and stored in a storage portion of the management apparatus 117.

An administrator can check or process the measurement data stored in the storage portion, or causes a display portion to display the measurement data, by using a computer included in the management apparatus 117. The management apparatus 117 can analyze the relationship between the operation state of the production apparatus 101 and the location of a worker by performing various processes by using the measurement data stored in the storage portion. If a worker is absent for a long time even though an error has occurred in the production apparatus 101, or the management apparatus 117 has created a procedure of movements for allowing a worker to work efficiently, the management apparatus 117 can issue an alert or instruction by using a display screen, or executes a notification process, such as sending a mail to the worker.

### Configuration of Information Network

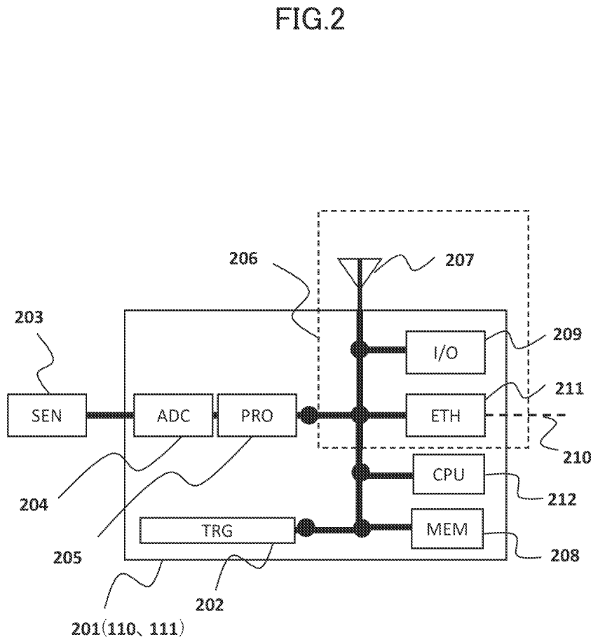

FIG. 2 is a schematic diagram illustrating a block configuration of the node apparatuses 110 and 111 illustrated in FIG. 1. Note that in FIG. 2, the function blocks represent functional elements that are necessary for describing features of the present embodiment. Thus, other function blocks that are commonly used and that are not directly related to the principle of the present invention for solving the problem are not illustrated. In addition, since the functional elements of FIG. 2 are illustrated conceptually so that the functions of the elements can be understood, the elements may not necessarily be connected with each other physically as illustrated in FIG. 2. For example, a specific configuration in which functional blocks are distributed or unified is not limited to the example illustrated in the figure, and part or all of the functional blocks may be functionally or physically distributed or unified in a predetermined unit, in accordance with a use state or the like. In addition, each functional block can be achieved by using hardware or software. That is, part of the function blocks can be achieved by a CPU 212, which serves as a control portion, reading and executing a control program stored, for example, in a storage device or a non transitory recording medium. In another case, part or all of the function blocks may be achieved by a hardware component such as an ASIC.

Anode apparatus 201 (i.e., the node apparatuses 110 and 111 illustrated in FIG. 1) includes the CPU 212 that controls the operation sequence of the whole of the node apparatus and the execution of a task. The CPU 212 reads a control program and control information from a storage portion 208 or a computer-readable recording medium (not illustrated), and executes the control program. The recording medium used may be a ROM, a flexible disk, an optical disk, a magneto-optical disk, a magnetic tape, a nonvolatile memory such as a USB memory, an SSD, or the like.

The node apparatus 201 can be connected with one or more sensors 203 disposed in the production apparatus 101; and includes a signal input portion 204 that converts analog signals outputted from the sensors 203, to digital signals. The signal input portion 204 includes one or more A/D converters that convert analog input signals to digital signals. Note that in another system, the signal input portion 204 may be included in the sensor 203, and the sensor 203 may output the digital signals.

The signal digitized in the signal input portion 204 is processed, if necessary, by a processing portion 205. The processing portion 205 combines one or more of the following processes, determines the order of the processes, and executes them. The following processes are as follows: no operation, a threshold comparison (binarization), an FFT process, a partial overall process, an envelope process, a frequency filter process, a differential process, an integral process, a wavelet process, an average value process, a standard deviation process, a maximum value process, a minimum value process, a peak-to-peak process, a peak hold process, an effective value process, a crest factor process, a form factor process, an impulse coefficient process, and a margin coefficient process. The processing portion 205 executes a signal processing that is suitable for determining the operation state of the production apparatus 101 and the location of a worker.

The node apparatus 201 also includes an input/output portion 206 that sends/receives information to/from an external apparatus. The node apparatus 201 outputs a signal or data, which has been processed by the processing portion 205, to an external apparatus via the input/output portion 206. The input/output portion 206 operates with, for example, the processing portion 205 under the control performed by the CPU 212. The input/output portion 206 includes a wireless-communication unit (communication portion) 207 that corresponds to the communication units 113 and 114 illustrated in FIG. 1. Preferably, the input/output portion 206 further includes a general-purpose input/output portion 211 and an I/O port 209 that allow the node apparatus 201 to communicate with a network 210 or an external apparatus via wire.

The input/output portion 206 sends/receives information to/from the storage portion 208. For example, the node apparatus 110 associates the measurement data outputted from the processing portion 205, with a node number (i.e., node identification information), a measurement task number (i.e., task identification information), and a measurement time; and temporarily stores the measurement data associated with the node number, the measurement task number, and the measurement time, in the storage portion 208. The node number serves as identification information for identifying the node apparatus 110 as an individual device, and the measurement time is a time at which the measurement was performed. Then, the input/output portion 206 reads the information from the storage portion 208, and transmits the information to the gateway apparatus 112 via the wireless-communication unit 207.

The node apparatus 201 also includes an event generation portion 202. The event generation portion 202 generates a trigger event that starts a corresponding one of various tasks, such as a measurement task in which the measurement is performed by using the sensor 203 and the measurement data is transmitted to the gateway apparatus 112. The event generation portion 202 autonomously generates a trigger event, for example, at predetermined time intervals in accordance with the type of a task; or generates a trigger event, if necessary, depending on the information sent from an external apparatus via the input/output portion 206. The event generation portion 202 generates a trigger event, for example, at time intervals, at a specified time, at a time when a trigger input signal is sent from an external apparatus, at a time when a task is called from a timer in the node apparatus, at a time when the node apparatus is called from the gateway apparatus, or at a time when the node apparatus is called from another node apparatus. The event generation portion 202 may be a dedicated piece of hardware such as a PLA, or may be a piece of software that is a control program for controlling the operation of the CPU 212.

The event generation condition of the event generation portion 202, the signal input condition of the signal input portion 204, the signal processing condition of the processing portion 205, and the input/output condition of the input/output portion 206 are stored in a task table of the storage portion 208. Note that the task table may be stored not in the storage portion 208, but in another storage device.

The measurement data measured by the sensor 203 and subjected to the signal processing performed by the processing portion 205 is stored in a RAM of the storage portion 208, associated with the measurement time (time stamp). The CPU 212 determines the operation state of the production apparatus 101 and the location of a worker by using the measurement data stored in the storage portion 208, creates data in which the determination result is associated with the time stamp, and transmits the data to the gateway apparatus 112 via the input/output portion 206. For example, the CPU 212 may determine the location of a worker, based on a binarized result obtained by comparing a measurement value from an infrared human sensor with a predetermined threshold value; and may determine the operation state of the production apparatus 101 by detecting a peak value or an average value of the driving current of the production apparatus 101. In this method, the amount of data required for the communication is small, but the excessive load may be applied to the CPU 212 for determining the operation state of the production apparatus 101 and the location of a worker. As countermeasures, the CPU 212 may associate the measurement data with the measurement time (time stamp), and transmit the measurement data, associated with the measurement time, from the node apparatus 201 to the gateway apparatus 112; and the management apparatus 117 may determine the operation state of the production apparatus 101 and the location of a worker.

The determination result or the measurement data transmitted from the node apparatus, and received and collected by the gateway apparatus 112 is stored in a storage portion (data storage portion) 33 of the management apparatus (server) 117 connected to the network 116.

### Management Apparatus

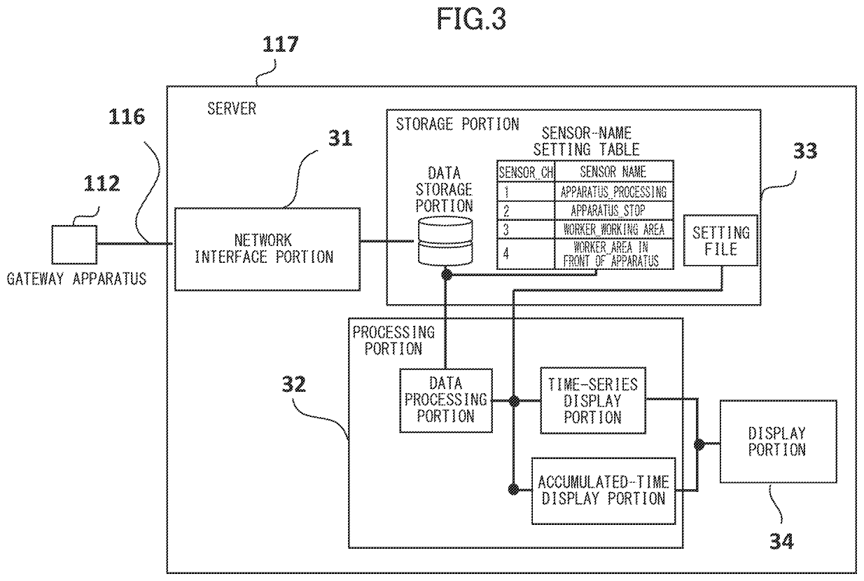

FIG. 3 is a schematic diagram illustrating a block configuration of the management apparatus (server) 117 illustrated in FIG. 1. Note that in FIG. 3, the function blocks represent functional elements that are necessary for describing features of the present embodiment. Thus, other function blocks that are commonly used and that are not directly related to the principle of the present invention for solving the problem are not illustrated. In addition, since the functional elements of FIG. 3 are illustrated conceptually so that the functions of the elements can be understood, the elements may not necessarily be connected with each other physically as illustrated in FIG. 3. For example, a specific configuration in which functional blocks are distributed or unified is not limited to the example illustrated in the figure, and part or all of the functional blocks may be functionally or physically distributed or unified in a predetermined unit, in accordance with a use state or the like. In addition, each functional block can be achieved by using hardware or software. That is, part of the function blocks can be achieved by a CPU, which serves as a control portion, reading and executing a control program stored, for example, in a storage device or a non transitory recording medium. In another case, part or all of the function blocks may be achieved by a hardware component such as an ASIC.

The management apparatus 117 includes a network interface portion 31, a processing portion 32, a storage portion 33, and a display portion 34. The network interface portion 31 serves as an input/output portion that connects the management apparatus 117 to the network 116. The processing portion 32 includes a CPU and executes a variety of types of signal processing. The storage portion 33 stores a variety of types of data and a control program.

The display portion 34 preferably includes an input portion that serves as a user interface. The display portion 34 may include a display device, such as a liquid crystal display or an organic electroluminescent display. The input portion may include an input device, such as a keyboard, a jog dial, a mouse, a pointing device, or a voice input device.

The processing portion 32 includes the CPU (not illustrated) that controls the operation sequence of the whole of the management apparatus 117 and the execution of a task. The CPU reads a control program and control information from the storage portion 33 or a computer-readable recording medium (not illustrated), and executes the control program. The recording medium used may be a ROM, a flexible disk, an optical disk, a magneto-optical disk, a magnetic tape, a nonvolatile memory such as a USB memory, an SSD, or the like.

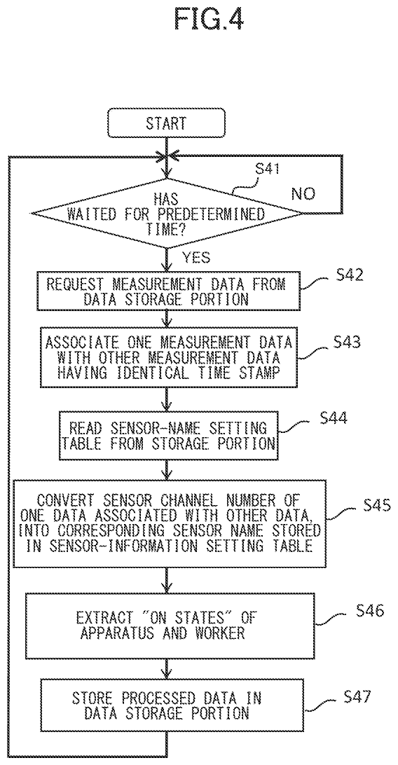

FIG. 4 is a flowchart illustrating a procedure of one example of data processing performed by the management apparatus 117. The management apparatus 117 regularly reads the data stored in the storage portion 33 and related to the operation state of the production apparatus 101 and the location of a worker; associates the operation state of the production apparatus 101 and the location of the worker with each other; and stores the data, in which the operation state of the production apparatus 101 and the location of the worker are associated with each other, in the storage portion 33.

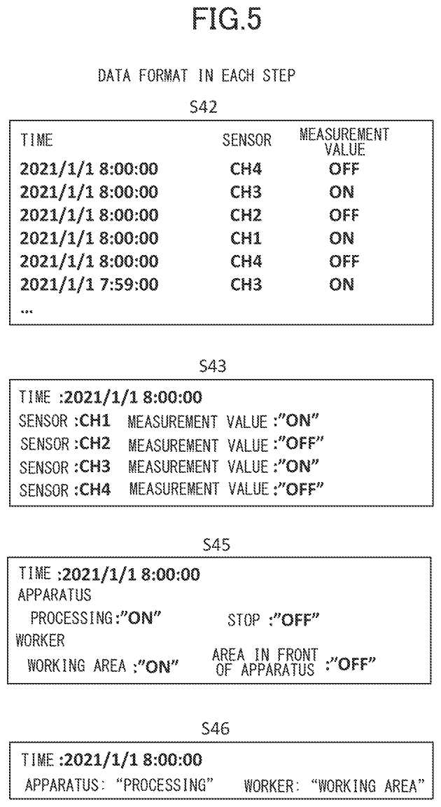

Since the processing portion 32 has only to execute this data processing regularly, not continuously, in the normal operation, the processing portion 32 waits in Step S41 until a predetermined time elapses. If the predetermined time has elapsed (Step S41: YES), then the processing portion 32 proceeds to Step S42, and requests from the storage portion 33 the measurement data (determination data) related to the operation state of the production apparatus 101 and the location of a worker. The format of data used in Step S42 is illustrated in the top diagram of FIG. 5. In Step S43, a data processing portion of the processing portion 32 associates one piece of the measurement data having been read from the data storage portion, with other pieces of the measurement data having an identical time stamp. The second diagram from the top of FIG. 5 illustrates an example of the data in which one piece of the measurement data is associated, in Step S43, with other pieces of the measurement data having an identical time stamp.

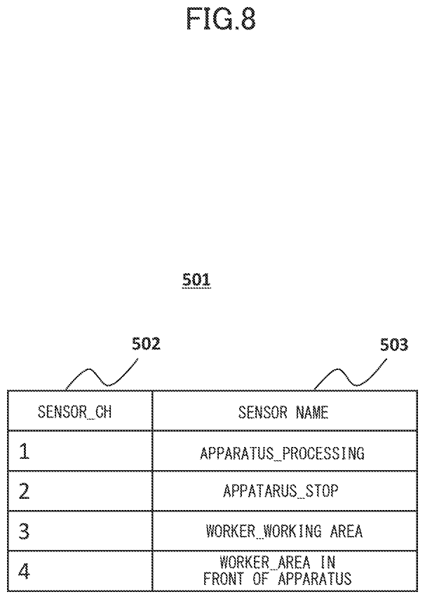

In Step S44, the processing portion 32 reads a sensor-name setting table from the storage portion 33. FIG. 8 illustrates a sensor-name setting table 501 in which a sensor channel number 502 and a sensor name 503 are associated with each other.

In Step S45, the processing portion 32 converts a sensor-channel number to a sensor name, in the measurement data in which one piece of the measurement data is associated with other pieces of the measurement data having an identical time stamp, depending on the sensor-name setting table 501 which has been read in Step S44.

In Step S46, the processing portion 32 extracts every piece of the measurement data in which a state flag of the production apparatus is “ON”, and every piece of the measurement data in which a location information flag of a worker is “ON”, from the measurement data in which one piece of the measurement data is associated with other pieces of the measurement data having an identical time stamp. The third diagram from the top of FIG. 5 illustrates an example of the measurement data obtained before the extraction is performed. In this example, the measurement data is associated with a time stamp “2021/1/18:00:00” that is a measurement time. As to the state flag of the production apparatus obtained at this time stamp, the processing state is “ON”, and the stop state is “OFF”. As to the location information flag of a worker obtained at this time stamp, the working area is “ON”, and the area in front of the apparatus is “OFF”. Thus, a piece of the measurement data indicating that the production apparatus is in the processing state, and a piece of the measurement data indicating that the location of a worker is the working area are extracted from the measurement data.

In Step S47, the processing portion 32 stores the data extracted in Step S46, in the storage portion 33. The bottom diagram of FIG. 5 illustrates an example of the measurement data stored in the storage portion 33. The measurement data stored in the storage portion 33 indicates that at a time “2021/1/1 8:00:00”, the production apparatus was in the processing state and a worker was in the working area.

After the processing portion 32 associates the information on the state of the production apparatus and the information on the location of a worker, with the time information (time information), and stores the information on the state of the production apparatus and the information on the location of a worker, associated with the time information, in the storage portion 33, the processing portion 32 ends the series of processes, returns to Step S41, and waits for the predetermined time again. After waiting for the predetermined time, the processing portion 32 performs Step S42 and the following processes (performed after Step S42) on the measurement data that has been newly collected via the node apparatus and the gateway apparatus while the processing portion 32 waited for the predetermined time.

In this manner, a data structure in which the information on the state of the production apparatus and the information on the location of a worker are associated with the time information (time information) is created and stored in the storage portion 33. By using the data structure created as described above, the management apparatus 117 can create a chart used for analyzing whether a worker is working appropriately in an appropriate location in accordance with the state of the production apparatus, and display the chart on the display portion.

### Creating and Displaying Time-Series Chart

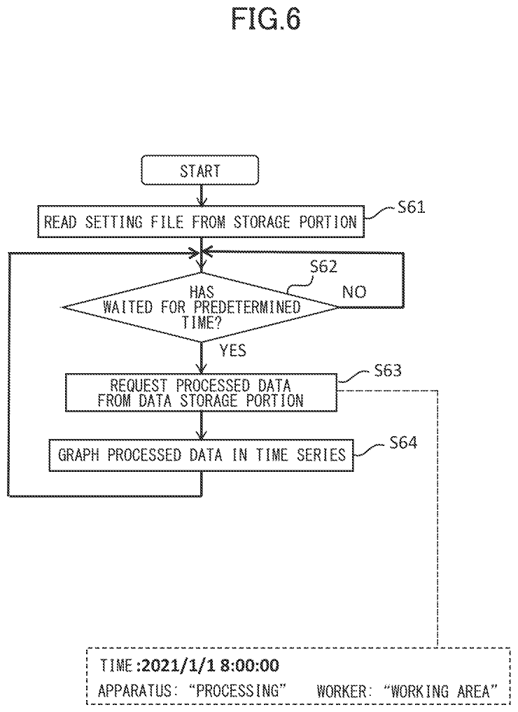

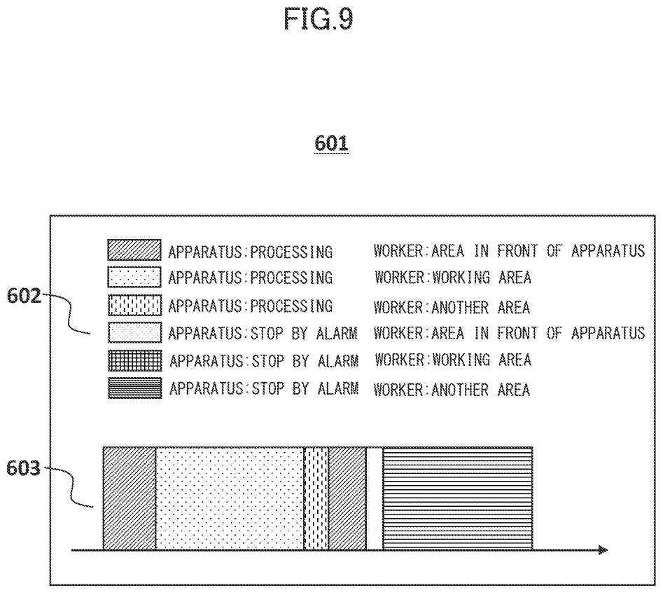

FIG. 6 is a flowchart illustrating a procedure of processes performed by the management apparatus 117 for creating and displaying a time-series chart 603 (FIG. 9) in which occurrence times of combinations of the state of the production apparatus and the location of a worker are displayed in time series.

In Step S61, a time-series display portion of the processing portion 32 reads a setting file used in this process, from the storage portion 33. The setting file contains information used for creating and displaying a time-series chart 603 and legends 602 on a time-series-chart display screen 601 illustrated in FIG. 9. The legends 602 indicate the state of the production apparatus and the location of a worker.

Since the time-series display portion has only to create and display the time-series chart regularly, not continuously, in the normal operation, the time-series display portion waits in Step S62 until a predetermined time elapses. The waiting time may be set as in Step S41 of the flowchart of FIG. 4. If the predetermined time has elapsed (Step S62: YES), then the time-series display portion proceeds to Step S63, and reads the data stored in the storage portion 33 in the above-described step S47, from the storage portion 33. In this operation, the time-series display portion obtains a data set in which the information on the state of the production apparatus, the information on the location of a worker, and the time information are associated with each other. As an example, the data set is illustrated in a dotted-line box of FIG. 6.

In Step S64, the time-series display portion creates image data of the time-series-chart display screen 601 (FIG. 9) by using the data obtained in Step S63 and the setting file obtained in Step S61, and causes the display portion 34 to display the time-series-chart display screen 601. Since the time-series-chart display screen 601 is displayed, an administrator can intuitively understand how the state of the production apparatus and the location of a worker have changed with time. Thus, the productivity can be increased, and the facility can be operated appropriately.

### Creating and Displaying Accumulated-Time Matrix

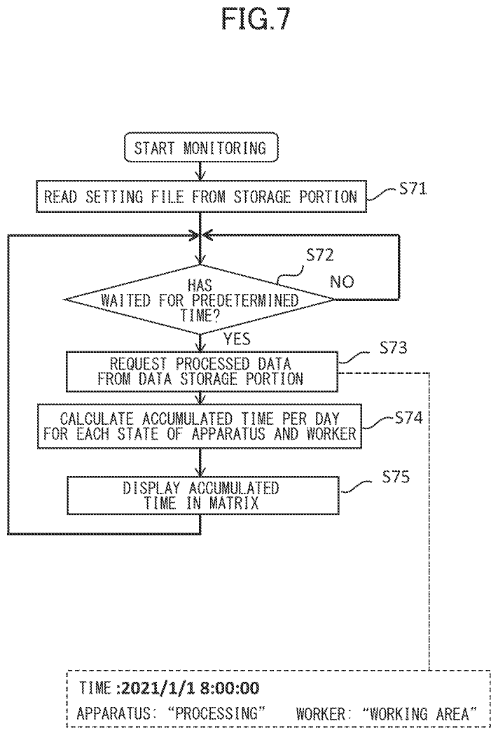

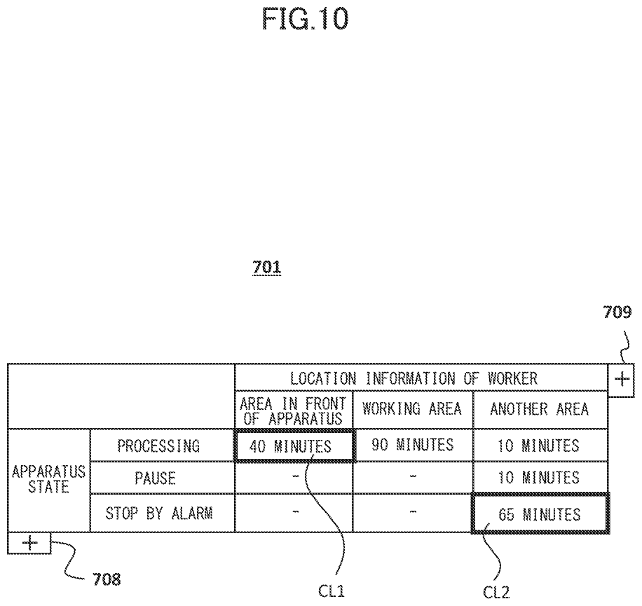

FIG. 7 is a flowchart illustrating a procedure of processes performed by the management apparatus 117 for creating and displaying an accumulated-time matrix display screen 701 (FIG. 10) obtained by calculating an accumulated time in a predetermined period of time for each combination of the state of the production apparatus and the location of a worker.

In Step S71, an accumulated-time display portion of the processing portion 32 reads a setting file used in this process, from the storage portion 33. The setting file contains information used for creating a matrix chart, a tab 708, and a tab 709 in the accumulated-time matrix display screen 701 illustrated in FIG. 10. The tab 708 is used for adding a state of the apparatus, and the tab 709 is used for adding location information of a worker.

Since the accumulated-time display portion has only to create and display the accumulated-time matrix display screen 701 regularly, not continuously, in the normal operation, the accumulated-time display portion waits in Step S72 until a predetermined time elapses. The waiting time may be set as in Step S41 of the flowchart of FIG. 4. If the predetermined time has elapsed (Step S72: YES), then accumulated-time display portion proceeds to Step S73, and reads the data stored in the storage portion 33 in the above-described step S47, from the storage portion 33. In this operation, the accumulated-time display portion obtains a data set in which the information on the state of the production apparatus, the information on the location of a worker, and the time information are associated with each other. As an example, the data set is illustrated in a dotted-line box of FIG. 7.

In Step S74, the accumulated-time display portion creates image data of the accumulated-time matrix display screen 701 (FIG. 10) by using the data obtained in Step S73 and the setting file obtained in Step S71, and causes the display portion 34 to display the accumulated-time matrix display screen 701, in Step S75. Since the accumulated-time matrix display screen 701 (FIG. 10) is displayed, an administrator can easily check the accumulated time in a combination of the state of the production apparatus and the location of a worker. Thus, the productivity can be increased, and the facility can be operated appropriately.

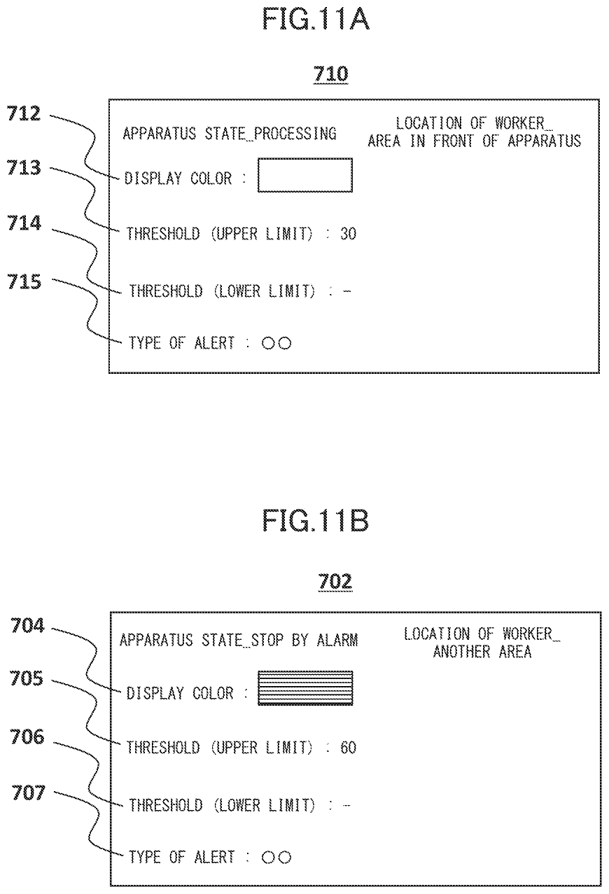

In addition, if an administrator selects (for example, clicks) a cell of the matrix chart displayed in the accumulated-time matrix display screen 701, an alert setting screen is displayed. In the alert setting screen, a condition for issuing an alert can be set for a combination (that corresponds to the selected cell) of the state of the production apparatus and the location of a worker. For example, if an administrator selects a cell indicated by a symbol CL1 in the accumulated-time matrix display screen 701 of FIG. 10, an alert setting screen 710 illustrated in FIG. 11A is displayed on the display portion 34. Thus, the administrator can set a display color 712 of the cell, an upper limit 713, a lower limit 714, and a type of alert 715 for the combination of the state of the apparatus and the location of a worker, by using the alert setting screen 710. The upper limit 713 is an upper limit of an allowable range of the accumulated time; the lower limit 714 is a lower limit of the allowable range of the accumulated time; and the type of alert 715 is a type of alert that is used for performing notification if the accumulated time becomes out of the allowable range. In this case, the production apparatus is in the processing state, and the worker is in the area in front of the production apparatus. Similarly, if an administrator selects a cell indicated by a symbol CL2 in the accumulated-time matrix display screen 701 of FIG. 10, an alert setting screen 702 illustrated in FIG. 11B is displayed on the display portion 34. Thus, the administrator can set a display color 704 of the cell, an upper limit 705, a lower limit 706, and a type of alert 707 for the combination of the state of the apparatus and the location of a worker, by using the alert setting screen 702. The upper limit 705 is an upper limit of an allowable range of the accumulated time; the lower limit 706 is a lower limit of the allowable range of the accumulated time; and the type of alert 707 is a type of alert that is used for performing notification if the accumulated time becomes out of the allowable range. In this case, the production apparatus is in the stop-by-alarm state, and the worker is in another area.

For example, there may be a case where an administrator checks the accumulated-time matrix display screen 701 (FIG. 10) and determines that it is not preferable for production efficiency that a worker was in the area in front of the production apparatus for 40 minutes even though the production apparatus was in the processing state and was performing the normal operation autonomously. In this case, the administrator can use the alert setting screen 710 illustrated in FIG. 11A, and set the upper limit 713 of the allowable range of the accumulated time, at 30 minutes per day as an example, for issuing an alert if the accumulated time exceeds 30 minutes in the combination.

In addition, there may be a case where an administrator checks the accumulated-time matrix display screen 701 (FIG. 10) and determines that it is not preferable for restoring the production apparatus to its normal operation early that a worker was in another area for 65 minutes even though the production apparatus was in the stop-by-alarm state. In this case, the administrator can use the alert setting screen 702 illustrated in FIG. 11B, and set the upper limit 705 of the allowable range of the accumulated time, at 60 minutes per day as an example, for coloring the cell CL2 with a conspicuous display color 704 and issuing an alert if the accumulated time exceeds 60 minutes in the combination.

For issuing the alert message, a pop-up may be displayed on the screen of the display portion 34, an e-mail may be sent to an administrator, or a notification may be sent to a terminal held by a worker. For example, there may be a case where although the management apparatus has issued an alert, a worker does not handle the error indicated by the alert and works in another area. For this case, an administrator can set an instruction (alert message) that instructs the worker to handle the error promptly if the worker has worked in the other area longer than a predetermined time. As a result, it is possible to facilitate the improvement of work in the production site.

In addition, if an administrator desires to add a new combination of the state of the production apparatus and the location of a worker for monitoring the accumulated time in the new combination, the administrator can click the tab 708 for adding a state of the production apparatus or the tab 709 for adding a location of a worker. If the administrator clicks the tab 708 or 709, an alert setting screen similar to the screen illustrated in FIG. 11A or 11B is displayed. After that, the administrator can set a display color, a threshold value (upper limit), a threshold value (lower limit), and a type of alert in the alert setting screen.

As described above, in the present embodiment, the management apparatus 117 collects the information on the state of the production apparatus 101, the information on the location of a worker, and the time information (time information) via the node apparatus and the gateway apparatus such that the information on the state of the production apparatus 101, the information on the location of the worker, and the time information are associated with each other, and stores the information on the state of the production apparatus 101, the information on the location of the worker, and the time information. Thus, the management apparatus 117 can calculate and display the accumulated time for each of combinations of the state of the production apparatus 101 and the location of a worker. In addition, the management apparatus 117 can set an allowable range of the accumulated time and a type of alert for each combination of the state of the production apparatus 101 and the location of a worker. The alert is issued if the accumulated time exceeds the allowable range. The use of the information processing apparatus and the information processing method allows an administrator to easily check the state of a production apparatus and the location of a worker in a production site, by using the information displayed on the management apparatus. Thus, the productivity can be increased, and the facility can be operated appropriately. In addition, if the time-series chart is created and displayed in addition to the accumulated-time matrix, an administrator can more accurately analyze the relationship between the state of the production apparatus and the location of a worker in a production site.

### Second Embodiment

### Information Processing System

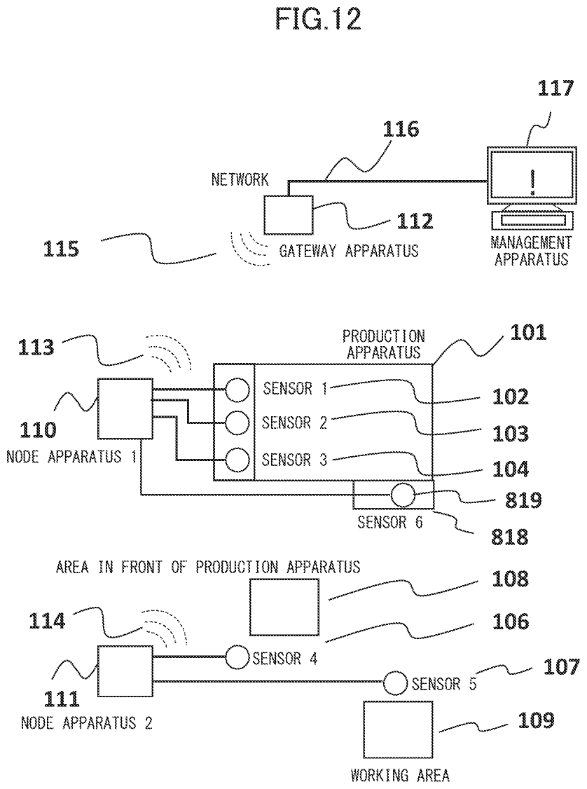

FIG. 12 is a schematic diagram of a production apparatus to which an information processing system of a second embodiment of the present invention is applied. The description for features identical to those of the first embodiment will be simplified or omitted.

The present embodiment differs from the first embodiment described with reference to FIG. 1, in that a failure prediction function is added to the configuration of the first embodiment. Specifically, in the present embodiment, a sensor 819 is disposed for monitoring the state of a portion (or component) 818 of the portions that constitute the production apparatus 101. For example, the portion 818 has a service life shorter than that of the production apparatus 101. The portion 818 may be a motor or a joint, and the sensor 819 may be a vibration sensor. Note that the sensor 819 may be an acceleration sensor, a pressure sensor, a photosensor, a torque sensor, a temperature sensor, or a sound wave sensor that can be used in accordance with the property of a portion (component) to be monitored.

In the present embodiment, the node apparatus 110 transmits the measurement data outputted from the sensor 819, to the gateway apparatus 112, in addition to the measurement data outputted from the sensors 102 to 104 that detect the operation state of the production apparatus 101. Specifically, the node apparatus 110 associates the measurement data outputted from the sensor 819, with the time information; and transmits the measurement data associated with the time information, to the gateway apparatus 112. The gateway apparatus 112 stores the measurement data outputted from the sensor 819, in the storage portion 33 of the management apparatus 117 such that the measurement data is associated with the time information. Note that the portion 818 to be monitored and the sensor 819 disposed in the production apparatus 101 are not limited, in number and type, to the above-described example; and can be set as appropriate in accordance with the type or an age of service of the production apparatus 101.

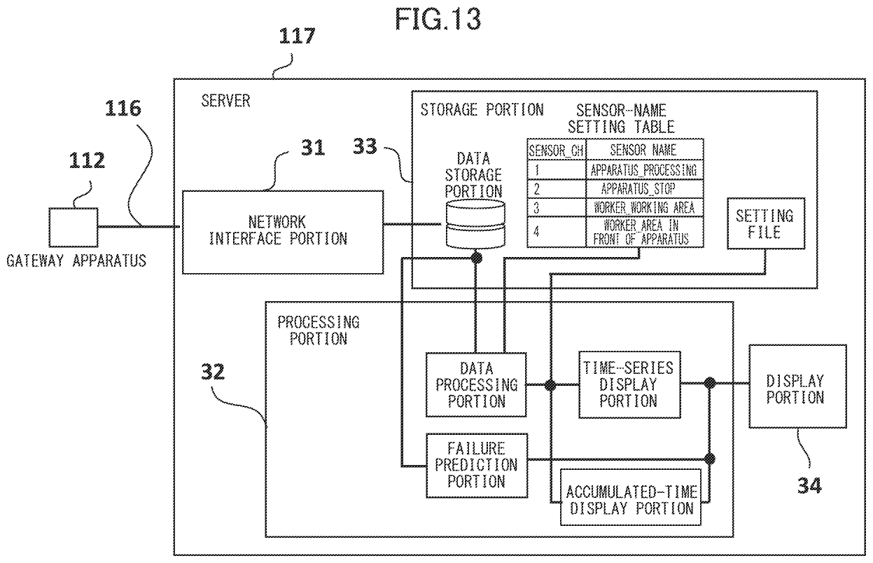

FIG. 13 is a schematic diagram illustrating a block configuration of a management apparatus (server) 117 of the present embodiment. The management apparatus of the present embodiment differs from the management apparatus of the first embodiment in that the processing portion 32 includes not only the accumulated-time display portion and the time-series display portion, but also a failure prediction portion. Since the processes performed by the accumulated-time display portion and the time-series display portion are the same as those of the first embodiment, the description thereof will be omitted, and the process performed by the failure prediction portion will be described below. The management apparatus 117 of the present embodiment regularly reads the measurement data outputted from the sensor 819 and stored in the storage portion 33; stores the data obtained by performing a failure prediction process on the measurement data, in the storage portion 33; displays a maintenance recommendation time on the display portion 34; and issues an alert.

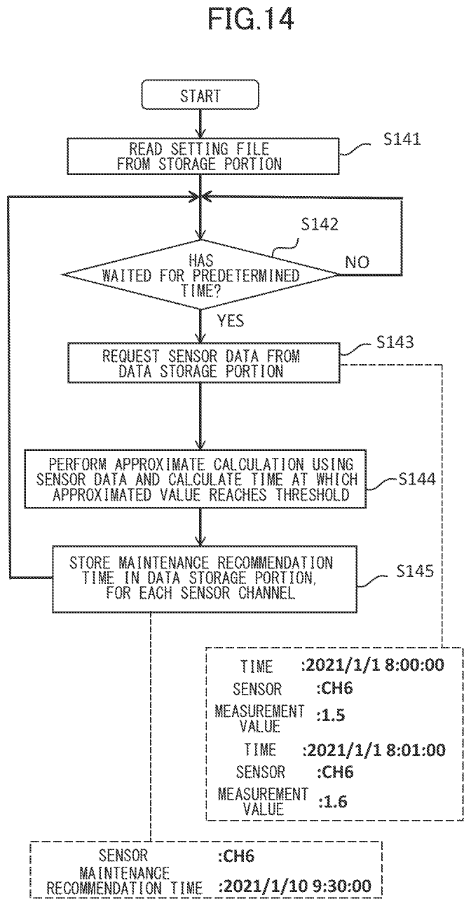

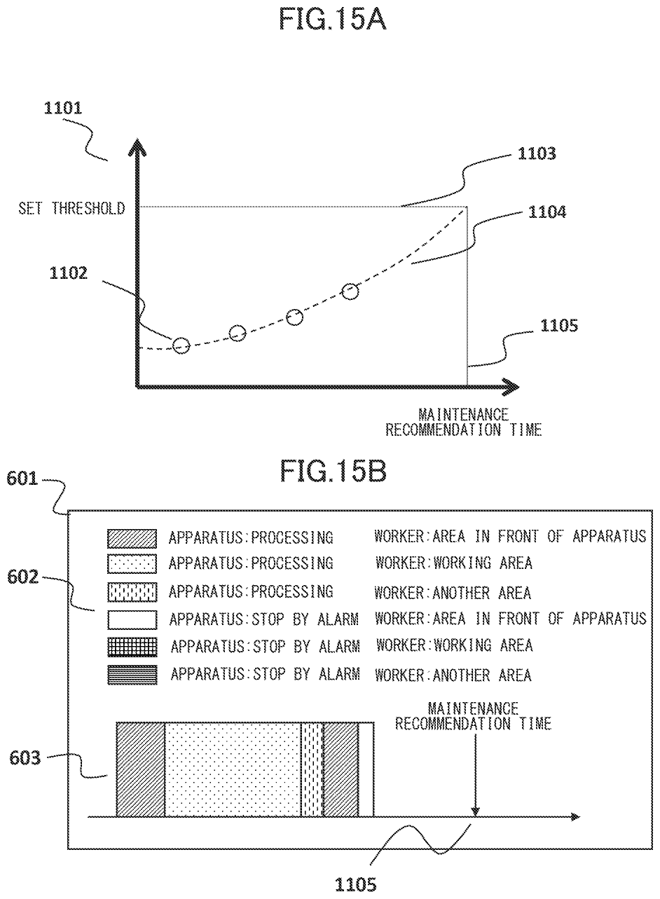

FIG. 14 is a flowchart illustrating a procedure of one example of data processing performed by the management apparatus 117. In Step S141, the failure prediction portion of the processing portion 32 reads a setting file used in this process, from the storage portion 33. The setting file contains information used for creating and displaying maintenance-recommendation-time information as illustrated in FIGS. 15A and 15B.

Since the failure prediction portion has only to execute the failure-prediction data processing regularly, not continuously, in the normal operation, the failure prediction portion waits in Step S142 until a predetermined time elapses. If the predetermined time has elapsed (Step S142: YES), then the processing portion 32 proceeds to Step S143, and requests from the storage portion 33 the measurement data related to the sensor 819. The format of data used in Step S143 is illustrated in a dotted-line box that is in the bottom right of FIG. 14.

In Step S144, the failure prediction portion calculates and extrapolates a predicted value for the future, based on the time-series measurement data, by performing the approximate calculation. FIG. 15A illustrates a graph 1101 for describing the process of Step S144. In the graph 1101, the horizontal axis represents the time, and the vertical axis represents the measurement value (e.g., vibration strength). Pieces of measurement data 1102 having been read from the storage portion 33 are indicated by dots, and the pieces of the measurement data 1102 are connected with each other by an approximate line 1104 obtained by the failure prediction portion performing an approximate calculation process. The approximate calculation process can be selected from the linear approximation and the polynomial approximation, and an administrator can set any approximate calculation process in advance in accordance with the property of a portion (component) to be monitored. The approximate line 1104 is extended (extrapolated) also in a future period of time in which no measurement data exists.

An administrator can set a threshold value 1103 in advance, and register the threshold value 1103 in the setting file stored in the storage portion 33. The threshold value 1103 corresponds to a level (e.g., a level of vibration strength) at which the maintenance is required in accordance with the property of the portion 818 that is being monitored. Since the failure prediction portion has already read the threshold value 1103 in the above-described Step S141, the failure prediction portion can calculate a time at which values of the approximate line 1104 reach the threshold value 1103, as a maintenance recommendation time 1105. If a plurality of portions 818 is being monitored, the failure prediction portion performs the same process sequentially on the portions 818, and calculates the maintenance recommendation time 1105 for each of the portions 818.

In Step S145, the failure prediction portion stores the maintenance recommendation time of each of the portions 818 that are being monitored, in the storage portion 33. The form of data is illustrated in a dotted-line box that is in the bottom left of FIG. 14. In the box, a sensor channel that corresponds to a portion that is being monitored is associated with a maintenance recommendation time. Note that in the present embodiment, since the relationship between the sensor channel and the portion 818 that is being monitored is defined in the sensor-name setting table 501 illustrated in FIG. 8, a maintenance recommendation time associated with a corresponding portion will be stored in the storage portion 33.

In the present embodiment, since the failure prediction portion causes the display portion 34 to display the image of FIG. 15A, an administrator can easily check the progress of deterioration of the portion 818, which is being monitored, and the maintenance recommendation time 1105.

In addition, when the time-series display portion is driven and displays the time-series chart on the display portion 34, the time-series display portion can use the information of the maintenance recommendation time stored in Step S145. That is, as illustrated in FIG. 15B, the time-series display portion can display the maintenance recommendation time 1105 in addition to the time-series chart 603.

As described above, in the present embodiment, the management apparatus 117 collects the information on the state of the production apparatus 101, the information on the location of a worker, the measurement data related to the portion 818 that is being monitored, and the time information (time information) via the node apparatus and the gateway apparatus such that the information on the state of the production apparatus 101, the information on the location of the worker, the measurement data related to the portion 818 that is being monitored, and the time information are associated with each other; and stores the information on the state of the production apparatus 101, the information on the location of the worker, the measurement data related to the portion 818, and the time information, which are associated with each other. Thus, the management apparatus 117 can calculate and display the accumulated time for each of combinations of the state of the production apparatus 101 and the location of a worker. In addition, the management apparatus 117 can set an allowable range of the accumulated time and a type of alert for each of combinations of the state of the production apparatus 101 and the location of a worker. The alert is issued if the accumulated time exceeds the allowable range. The use of the information processing apparatus and the information processing method allows an administrator to easily check the relationship between the state of a production apparatus and the location of a worker in a production site, by using the information displayed on the management apparatus. Thus, the productivity can be increased, and the facility can be operated appropriately. In addition, since the management apparatus 117 creates and displays not only the accumulated-time matrix, but also the time-series chart and the information on the maintenance recommendation time, an administrator can easily check the relationship between the state of a production apparatus in a production site, the location of a worker, and a maintenance recommendation time. Thus, the administrator can appropriately make a maintenance plan of the production apparatus; and efficiently manage the operation state of the production apparatus and the location of a worker, based on the maintenance plan.

### Modifications

The present invention is not limited to the above-described embodiments, and can be variously modified within the technical concept of the present invention. For example, the above-described different embodiments may be embodied, combined with each other.

The information processing method and the information processing apparatus of the present invention can be used for managing not only the production apparatus and the production facility but also various machines and facilities operated in cooperation with a worker, such as an industrial robot, a service robot, and a processing machine that is numerically controlled by a computer. For example, the present disclosure can be applied to mechanical equipment and a facility that are operated in cooperation with a worker. The mechanical equipment can automatically perform expansion and contraction, bending and stretching, up-and-down movement, right-and-left movement, pivot, or combined movement thereof, in accordance with information stored in the storage device of the control device.

In addition, a production system including a node apparatus, a gateway apparatus that can communicate with the node apparatus, and a management apparatus, those constituting an information processing system to which the present invention is embodied, and a manufacturing apparatus, is also included in the embodiments of the present invention. In addition, a method of manufacturing products by using the above-described production system is also included in the embodiments of the present invention. When products are manufactured, an input portion of the node apparatus is connected with a sensor that obtains information on the state of the manufacturing apparatus, and with a sensor that detects the location of a worker, and the data obtained from the sensors is transmitted by using a communication portion, from the node apparatus to the gateway apparatus. Since the management apparatus creates and displays the accumulated-time matrix for an administrator, the administrator can easily check the information on the state of the production facility and the information on the location of a worker in the production of products. A method of manufacturing products by using the production system is also included in the embodiments of the present invention. A control program that can execute the above-described information processing method and control method, and a computer-readable recording medium that stores the control program are also included in the embodiments of the present invention.

The present invention may be embodied by supplying a program that achieves one or more functions of the above-described embodiments, to a system or a device via a network or a storage medium, and by causing one or more processors of the system or the device to read and execute the program. In addition, the present disclosure may be embodied by using a circuit (e.g., an ASIC) that achieves one or more functions.

The present invention can provide the information processing method and the information processing apparatus that are effective for increasing the productivity and operating the facility appropriately by using the information on the location of a worker and the information on the state of the facility.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-26907, filed Feb. 24, 2022 which is hereby incorporated by reference herein in its entirety.

What is claimed is:

1. A method of controlling an information processing apparatus, the method comprising:
obtaining, by the information processing apparatus, information on a location of a worker associated with time information, and information on a state of a production apparatus associated with the time information; and
displaying, by the information processing apparatus, an accumulated time in a predetermined combination of the location of the worker and the state of the production apparatus.

2. The method of controlling the information processing apparatus according to claim 1, the method further comprising:
displaying, by the information processing apparatus, an accumulated-time matrix that contains accumulated times obtained in a plurality of predetermined combinations of the location of the worker and the state of the production apparatus.

3. The method of controlling the information processing apparatus according to claim 2, the method further comprising:
accepting, by the information processing apparatus, a selection of any of the plurality of predetermined combinations of the location of the worker and the state of the production apparatus in the accumulated time matrix; and
displaying, by the information processing apparatus, an alert setting screen that corresponds to a combination selected from the plurality of predetermined combinations.

4. The method of controlling the information processing apparatus according to claim 3, wherein the alert setting screen contains information on an allowable range of the accumulated time and/or information on an alert process executed if the accumulated time exceeds the allowable range.

5. The method of controlling the information processing apparatus according to claim 4, the method further comprising:
accepting, by the information processing apparatus, registration of the information on the allowable range of the accumulated time and/or the information on the alert process executed if the accumulated time exceeds the allowable range, via the alert setting screen.

6. The method of controlling the information processing apparatus according to claim 1, the method further comprising:
displaying, by the information processing apparatus, a time-series chart in which occurrence times of predetermined combinations of the location of the worker and the state of the production apparatus are displayed in time series.

7. The method of controlling the information processing apparatus according to claim 6, the method further comprising:
displaying, by the information processing apparatus, a maintenance recommendation time of the production apparatus in the time-series chart by performing extrapolation.

8. The method of controlling the information processing apparatus according to claim 1, the method further comprising:
executing, by the information processing apparatus, a preset process if an accumulated time in a predetermined combination of the location of the worker and the state of the production apparatus becomes out of an allowable range that is set for the predetermined combination.

9. The method of controlling the information processing apparatus according to claim 8, wherein the preset process is a process that issues an alert.

10. A computer-readable non-transitory recording medium storing a control program that causes a computer included in the information processing apparatus to execute the method of controlling the information processing apparatus according to claim 1.

11. An information processing apparatus comprising a processing portion configured to
obtain information on a location of a worker associated with time information, and information on a state of a production apparatus associated with the time information, and
display an accumulated time on a display portion by using the obtained information, the accumulated time being obtained in a predetermined combination of the location of the worker and the state of the production apparatus.

12. The information processing apparatus according to claim 11, wherein the processing portion is configured to cause the display portion to display an accumulated-time matrix that contains accumulated times obtained in a plurality of predetermined combinations of the location of the worker and the state of the production apparatus.

13. The information processing apparatus according to claim 12, wherein the processing portion is configured to
accept a selection of any of the plurality of predetermined combinations of the location of the worker and the state of the production apparatus in the accumulated-time matrix, and
cause the display portion to display an alert setting screen that corresponds to a combination selected from the plurality of predetermined combinations, if the processing portion accepts the selection.

14. The information processing apparatus according to claim 13, wherein the alert setting screen contains information on an allowable range of the accumulated time and/or information on an alert process executed if the accumulated time exceeds the allowable range.

15. The information processing apparatus according to claim 14, wherein the processing portion is configured to
accept input of the information on the allowable range of the accumulated time and/or the information on the alert process executed if the accumulated time exceeds the allowable range, via the alert setting screen, and
register the information on the allowable range of the accumulated time and/or the information on the alert process, in a storage portion.

16. The information processing apparatus according to claim 11, wherein the processing portion is configured to cause the display portion to display a time-series chart in which occurrence times of the predetermined combination of the location of the worker and the state of the production apparatus are displayed in time series.

17. The information processing apparatus according to claim 16, wherein the processing portion is configured to cause the display portion to display a maintenance recommendation time of the production apparatus in the time-series chart by performing extrapolation.

18. The information processing apparatus according to claim 11, wherein the processing portion is configured to execute a preset process if the accumulated time in the predetermined combination of the location of the worker and the state of the production apparatus becomes out of an allowable range that is set for the predetermined combination.

19. The information processing apparatus according to claim 18, wherein the preset process is a process that issues an alert.

20. An information processing system comprising:
the information processing apparatus according to claim 11;
a node apparatus configured to transmit a measurement value related to the location of the worker and/or a measurement value related to the state of the production apparatus; and
a gateway apparatus configured to
receive the measurement value transmitted by the node apparatus and related to the location of the worker and/or the measurement value transmitted by the node apparatus and related to the state of the production apparatus, and
store the measurement value related to the location of the worker and/or the measurement value related to the state of the production apparatus, in a storage portion of the information processing apparatus.

21. A production system comprising:
the information processing system according to claim 20; and
the production apparatus.

22. A method of manufacturing products comprising: producing products by using the production system according to claim 21.
